(19) United States
(12) Patent Application Publication
(10) Pub. No.: US 2007/0011145 A1
(43) Pub. Date: Jan. 11, 2007

(54) System and method for operation control functionality

(76) Inventor: Matthew Snyder, Vancouver (CA)

Correspondence Address: MORGAN & FINNEGAN, L.L.P., 3 World Financial Center, New York, NY, 10281-2101, US

(21) Appl. No.: 11/195,909

(22) Filed: Aug. 2, 2005

Related U.S. Application Data
(63) Continuation-in-part of application No. 11/177,872, filed on Jul. 8, 2005.

(51) Int. Cl. G06F 17/30

(52) U.S. Cl. 707/3

(57) ABSTRACT

Systems and methods applicable, for instance, in operation control functionality. For example, a node and/or other computer might maintain one or more node information arrays, might provide some or all of one or more node information arrays to other nodes and/or other computers, and/or might receive some or all of one or more node information arrays from other nodes and/or other computers. Node information arrays might, for example, be employed in a number of ways. For instance, a node and/or other computer might employ some or all of maintained node information arrays and/or some or all of received node information arrays in making one or more determinations regarding its operation. One or more search operations might, for example, be performed.

This application is a continuation-in-part of U.S. application Ser. No. 11/177,872 filed Jul. 8, 2005 and entitled “System and Method for Operation Control Functionality”, which is incorporated herein by reference.

### FIELD OF INVENTION

This invention relates to systems and methods for operation control functionality.

### BACKGROUND INFORMATION

In recent times, there has been an increase in the use of nodes and/or other computers. For example, many users have come to prefer using nodes and/or other computers (e.g., wireless nodes) for activities such as, for instance, media use (e.g., audio, video, and/or image use), communications (e.g., voice and/or text communications), gaming, and/or productivity work (e.g., writing, calculation, and/or presentation work) over other ways of performing such activities.

Accordingly, there may be interest in technologies applicable, for instance, in node operation.

### SUMMARY OF THE INVENTION

According to embodiments of the present invention there are provided systems and methods applicable, for instance, in operation control functionality.

For example, in various embodiments a node and/or other computer might maintain one or more node information arrays, might provide some or all of one or more node information arrays to other nodes and/or other computers, and/or might receive some or all of one or more node information arrays from other nodes and/or other computers.

Node information arrays might, in various embodiments, be employed in a number of ways. For example, in various embodiments a node and/or other computer might employ some or all of maintained node information arrays and/or some or all of received node information arrays in making one or more determinations regarding its operation. In various embodiments, one or more search operations might be performed.

### BRIEF DESCRIPTION OF THE DRAWINGS

FIG. 1 shows exemplary steps involved in node information array maintenance operations according to various embodiments of the present invention.

FIG. 2. shows exemplary steps involved in node information array dispatch and receipt operations according to various embodiments of the present invention.

FIG. 3 shows exemplary steps involved in operation determination operations according to various embodiments of the present invention.

FIG. 4 shows exemplary steps involved in calculation and prediction operations according to various embodiments of the present invention.

FIG. 5 shows exemplary steps involved in search operations according to various embodiments of the present invention.

FIG. 6 shows exemplary display according to various embodiments of the present invention.

FIG. 7 shows an exemplary architectural view according to various embodiments of the present invention.

FIG. 8 is an exemplary descriptive figure depicting various aspects of various embodiments of the present invention.

FIG. 9 is a further exemplary descriptive figure depicting various aspects of various embodiments of the present invention.

FIG. 10 shows an exemplary computer.

FIG. 11 shows a further exemplary computer.

### DETAILED DESCRIPTION OF THE INVENTION

General Operation

According to embodiments of the present invention there are provided systems and methods applicable, for instance, in operation control functionality.

For example, in various embodiments a node and/or other computer might maintain one or more node information arrays, might provide some or all of one or more node information arrays to other nodes and/or other computers, and/or might receive some or all of one or more node information arrays from other nodes and/or other computers. A node and/or other computer might, in various embodiments, provide some or all of one or more node information arrays to other nodes and/or other computers in response to a received communication (e.g., a query).

Node information arrays might, in various embodiments, be employed in a number of ways. For example, in various embodiments a node and/or other computer might employ some or all of maintained node information arrays and/or some or all of received node information arrays in making one or more determinations regarding its operation. Such determinations might, in various embodiments, regard search operation and/or peer-to-peer operation.

One or more rules might, in various embodiments, be followed in employing maintained node information arrays and/or received node information arrays in making such determinations. Such rules might, in various embodiments, be distributed via peer-to-peer.

Moreover, in various embodiments calculations regarding node information arrays might be performed, and/or prediction regarding future node information arrays might be made. Additionally, in various embodiments one or more search operations might be performed.

Various aspects of the present invention will now be discussed in greater detail.

Node Information Array Maintenance Operations

According to various embodiments of the present invention, a node and/or other computer (e.g., a wireless node, a personal computer, and/or a server) may maintain one or more node information arrays. Such functionality may be implemented in a number of ways.

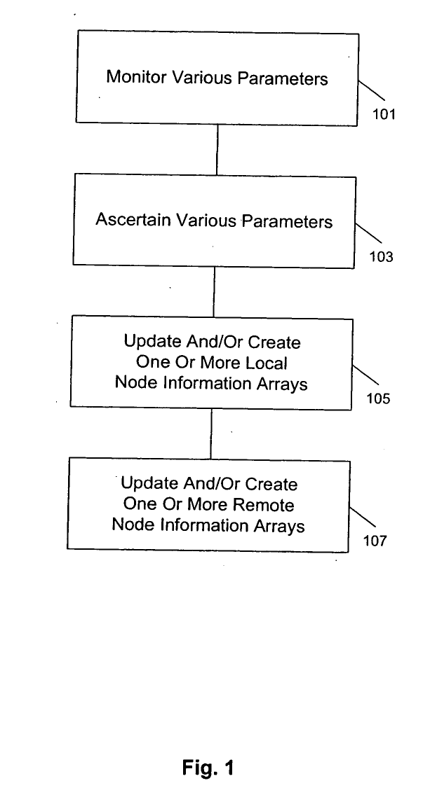

With respect to FIG. 1 it is noted that, for instance, the node and/or other computer may monitor various parameters (step 101) and/or may ascertain various parameters (step 103).

Accordingly, for example, one or more software modules running remote from and/or at the node and/or other computer might communicate with one or more other software modules running remote from and/or at the node and/or other computer, and/or with one or more hardware components of the node and/or other computer.

Such communication between software modules might, for instance, involve Simple Object Access Protocol (SOAP), Java Messaging Service (JMS), Remote Method Invocation (RMI), Remote Procedure Call (RPC), sockets (e.g., Transmission Control Protocol (TCP) and/or User Datagram Protocol (UDP) sockets), pipes, streams (e.g., simple and/or complex streams), streaming communications, and/or messaging-based interfaces. Such communication with hardware components might, for instance, involve communication with one or more software modules providing access to the hardware components and/or performing address space access.

Various parameters may, according to various embodiments of the present invention, be monitored by the node and/or other computer.

For example, the node and/or other computer might monitor communication access type and/or communication signal quality (e.g., via one or more software modules running remote form and/or at the node and/or other computer communicating with communications hardware of the node and/or other computer).

Such communications hardware might, for instance be Universal Mobile Telecommunications Service (UMTS), General Packet Radio Service (GPRS), Bluetooth, wireless local area network (e.g., WiFi (Wireless Fidelity)), Ultra Wide Band (UWB), IrDA (Infrared Data Association), and/or wired network (e.g., Ethernet) hardware. Such WiFi hardware might, for instance, be IEEE 802.11b and/or IEEE 802.11g hardware. To illustrate by way of example, such monitoring of communication access type might find WiFi and/or UMTS to be employed and/or available.

As another example, the node and/or other computer might monitor power source information (e.g., via one or more software modules running remote form and/or at the node and/or other computer communicating with power management hardware of the node and/or other computer). So communicating with power management hardware the one or more software modules might come to learn of one or more power sources available for use by the node and/or other computer, one or more power sources presently being used by the node and/or other computer, and/or one or more power source statuses.

Such power sources available for use and/or presently being used might, for instance, include battery, fuel cell, automotive, and/or wall outlet. Such power source statuses might, for instance, include power source level (e.g., percentage and/or number of time units used and/or remaining and/or charging status (e.g., whether or not charging is occurring, and/or percentage and/or number of time units of charge provided to the power source and/or remaining to provide to the power source). As yet another example, the node and/or other computer might monitor time and/or date (e.g., via one or more software modules running remote form and/or at the node and/or other computer communicating with timekeeping hardware of the node and/or other computer, and/or with one or more software modules offering time and/or date information running remote from and/or at the node and/or other computer). Such software modules offering time and/or date information might, for example, be ones running at and/or in communication with a network time source.

As still another example, the node and/or other computer might monitor its location (e.g., via one or more software modules running remote from and/or at the node and/or other computer communicating with communications hardware and/or with location determination hardware of the node and/or other computer).

Such location determination hardware might, for instance, be Global Positioning System (GPS) hardware, and/or cellular positioning (e.g., using Global System for Mobile Communications (GSM), Universal Mobile Telecommunications Service (UMTS), and/or Code Division Multiple Access 2000 (CDMA2000) base station cell identifiers and/or network identifiers). Such communications hardware might, for instance be of the sort discussed above.

So communicating with location determination hardware the one or more software modules might, for instance, learn of geographical coordinates describing the present location of the node and/or other computer. So communicating with communications hardware the one or more software modules might, for instance, learn of geographical coordinates describing the present location of the node and/or other computer, one or more cell identifiers corresponding to one or more cells providing communications link to the node and/or other computer, and/or one or more network identifiers corresponding to one or more networks to which the node and/or other computer is linked. So communicating with communications hardware the one or more software modules might come to learn of such geographical coordinates, for example, in the case where the communications hardware is involved in receiving such from a beacon (e.g., a Bluetooth beacon) outputting geographical location information.

As another example, the node and/or other computer might monitor present usage status (e.g., via one or more software modules running remote from and/or at the node and/or other computer communicating with hardware of the node and/or other computer, and/or with one or more other software modules running remote from and/or at the node and/or other computer). Such usage status might, for instance, regard whether or not the node and/or other computer is presently being employed in phone call operations, Short Message Service (SMS) operations, Multimedia Messaging Service (MMS) operations, email operations, chat operations, web browsing operations, media use operations (e.g., use of local and/or remote audio and/or video), gaming operations (e.g., local gaming, and/or gaming involving remote nodes and/or other computers), Internet use operations, productivity operations (e.g., use of organizer, word processing, spreadsheet, and/or presentation software), headset use, and/or car kit use. It is noted that, in various embodiments, such status might alternately or additionally regard whether or not the node and/or other computer is presently idle.

As a further example, the node and/or other computer might monitor status regarding friendly nodes and/or other computers (e.g., via one or more software modules running remote from and/or at the node and/or other computer communicating with hardware of the node and/or other computer, and/or with one or more other software modules running remote from and/or at the node and/or other computer).

Such status might, for instance, regard whether or not the node and/or other computer was in proximity communication range with such friendly nodes and/or other computers, and/or whether or not the node and/or other computer was in communication with such friendly nodes and/or other computers. Such friendly nodes and/or other computers might, for instance, be nodes and/or other computers trusted by the node and/or other computer and/or by its user (e.g., nodes and/or other computers indicated to be “trusted” (e.g., by a user of the node and/or other computer), and/or nodes and/or other computers for which the node and/or other computer possesses one or more certificates), be nodes and/or other computers indicated to be “friendly” (e.g., by a user of the node and/or other computer), and/or be nodes and/or other computers corresponding to individuals known by and/or friends of the user of the node and/or other computer (e.g., individuals listed in an address book of the user of the node and/or other computer, and/or individuals indicated by the user). Such indication might, for example, involve employment of a graphical user interface (GUI) and/or other interface (e.g., an interface provided by the node and/or other computer). It is noted that, in various embodiments, device discovery and/or service discovery might be employed in monitoring status.

According to various embodiments of the present invention, various parameters (e.g., parameters regarding data transfer) may be ascertained by the node and/or other computer.

For example, the node and/or other computer might estimate the delay that would be experienced by a node and/or other computer to which download was provided. In making such an estimate, the node and/or other computer might, in various embodiments, take into account one or more rules that it was following.

As another example, the node and/or other computer might estimate the throughput that would be experienced by a node and/or other computer to which download was provided. Such an estimate might, in various embodiments, take into account second order statistics such as, for instance, throughput variation.

As yet another example, the node and/or other computer might ascertain amount of data that it is allowed to transfer (e.g., maximum amount of data that it is allowed to transfer). Such an amount of data might, for instance, be in accordance with specification provided by a user of the node and/or other computer (e.g., via GUI and/or other interface). Such a parameter might, for example, be applicable in the case where the node and/or other computer is a member of one or more peer-to-peer communities employing upload-download ratios.

Maintained node information arrays might, for instance, exist at a remote and/or local store accessible by the node and/or other computer. Moreover, maintained node information arrays might, for instance, include one or more parameters (e.g., one or more parameters of the sort discussed above). Monitoring and/or ascertaining parameters the node and/or other computer might, in various embodiments, update and/or create one or more maintained node information arrays.

It is noted that, in various embodiments, the node and/or other computer might maintain a single node information array. It is further noted that, in various embodiments, the node and/or other computer might maintain multiple node information arrays. For instance, one or more local node information arrays might be maintained, and/or one or more remote node information arrays might be maintained. Such local node information arrays might, in various embodiments, be employable by the node and/or other computer in making one or more determinations regarding its operation, but not provided to other nodes and/or other computers. Such remote node information arrays might, in various embodiments, be providable to other nodes and/or other computers.

To illustrate by way of example, the node and/or other computer might maintain a local node information array including one or more communication access type parameters, one or more communication signal quality parameters, one or more power source information parameters, one or more time and/or date parameters, one or more location parameters, one or more usage status parameters, and/or one or more friendly node and/or other computer status parameters. In various embodiments, monitoring and/or ascertaining parameters the node and/or other computer might update and/or create one or more local node information arrays (step 105).

To further illustrate by way of example, the node and/or other computer might maintain a remote node information array including one or more delay parameters, one or more throughput parameters, one or more data transfer amount parameters, and/or one or more friendly node and/or other computer status parameters. In various embodiments, monitoring and/or ascertaining parameters the node and/or other computer might update and/or create one or more remote node information arrays (step 107).

It is noted that one or more parameters might, in various embodiments, be conveyed as numerical values. Alternately or additionally, one or more parameters might, in various embodiments, be conveyed as text, textual descriptions, and/or judgments. To illustrate by way of example a delay parameter might be conveyed as “5 seconds” and/or in and/or as “short”. In various embodiments, various node information array maintenance functionality discussed herein may be implemented via one or more software modules running remote from and/or at the node and/or other computer. Such software modules might, in various embodiments, be loaded onto the node and/or other computer during manufacture, sale, and/or activation, be transferred to the node and/or other computer from another node and/or other computer (e.g., via proximity connection and/or via the Internet), and/or be distributed via peer-to-peer.

Node Information Array Dispatch and Receipt Operations

According to various embodiments, the node and/or other computer may receive some or all of one or more node information arrays from another node and/or other computer, and/or may provide some or all of one or more node information arrays to another node and/or other computer. For instance, the node and/or other computer might receive from another node and/or other computer some or all of one or more node information arrays (e.g., remote node information arrays) maintained by that other node and/or other computer, and/or may provide some or all of one or more maintained node information arrays (e.g., remote node information arrays) to another node and/or other computer. Such functionality may be implemented in a number of ways.

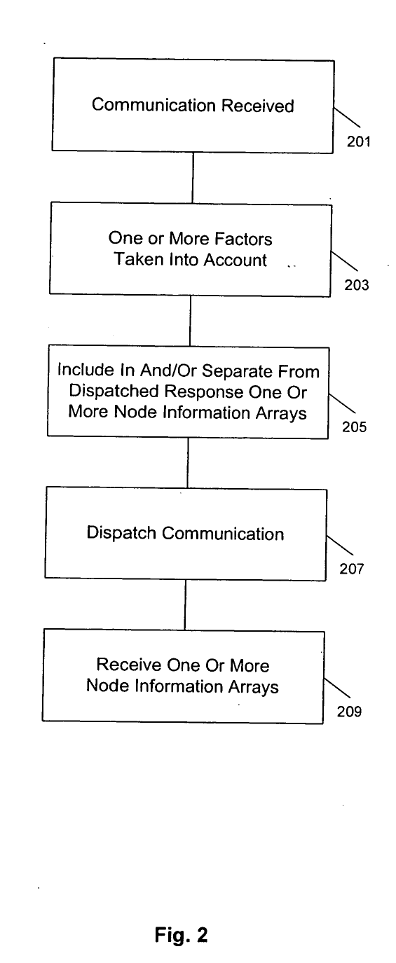

With respect to FIG. 2 it is noted that, for example, in the case where the node and/or other computer receives a communication (step 201) (e.g., a query, a message, and/or a communication between software modules (e.g., of the sort discussed above)), the node and/or other computer might include in and/or separate from a dispatched response to the communication some or all of one or more of its maintained node information arrays (e.g., one or more remote node information arrays) (step 205). Such a query might, for instance, be a peer-to-peer query, a query dispatched by a node and/or other computer performing discovery (e.g., device discovery and/or service discovery), and/or a query seeking data (e.g., data meeting criteria specified by the query). Such a message might, for instance, be a an email, an SMS message, and/or an MMS message.

Provision of node information arrays (e.g., maintained node information arrays) may be implemented in a number of ways. For example, the node and/or other computer might provide some or all of one or more node information arrays (e.g., one or more of its maintained node information arrays) via one or more communications (e.g., of the sort discussed above). As another example the node and/or other computer might provide some or all of one or more node information arrays (e.g., one or more of its maintained node information arrays) via one or more custom headers and/or custom header entries.

To illustrate by way of example, one or more Open Systems Interconnection (OSI) layer 7 (application layer) messaging headers might be employed to convey parameters: “m-delay” headers might be employed to convey one or more delay parameters, one or more “m-throughput” headers might be employed to convey one or more throughput parameters, and/or one or more “m-max_data” headers might be employed to convey one or more data transfer amount parameters. Such headers might, for example, be employed above the communications interface as part of application layer messages and/or communication among software modules (e.g., distributed objects) as peer-to-peer, email, SMS, MMS, and/or headers corresponding to one or more OSI layers (e.g., layer 7). It is noted that, in various embodiments, Extensible Markup Language (XML) might be employed in provision of maintained node information arrays.

In various embodiments, in the case where the node and/or other computer dispatches a communication (e.g., of the sort discussed above) (step 207), the node and/or other computer might receive some or all of one or more node information arrays (e.g., one or more remote node information arrays) from one or more nodes and/or other computers (step 209). Such nodes and/or other computers might, in various embodiments, provide the some or all of the one or more arrays by acting in a manner analogous to that discussed above.

It is noted that, in various embodiments, included in and/or separate from dispatch of some or all of one or more node information arrays might be one or more corresponding expiration indications (e.g., expiation dates). It is noted that such an expiration indication might, for instance, indicate that a corresponding node information array should, after expiration has occurred (e.g., after an expiration date has passed), be considered to be invalid by a node and/or other computer receiving the node information array.

It is further noted that, in various embodiments, the node and/or other computer might take one or more factors into account in providing some or all of one or more node information arrays to another node and/or other computer (step 203), and/or one or more nodes and/or other computers may take one or more factors into account in providing some or all of one or more node information arrays to the node and/or other computer.

For example, in various embodiments, some or all of one or more provided node information arrays might have content dependent upon the node and/or other computer to which they are provided, and/or upon data received from the node and/or other computer to which they are provided. Accordingly, so providing some or all of one or more node information arrays might, for example, involve the creation of one or more node information arrays, and/or the modification of one or more node information arrays (e.g., with retention of an original node information array and dispatch of a modified version of that node information array). For instance, some or all of one or more provided node information arrays might have content dependent upon data dispatched via a received communication (e.g., of the sort discussed above).

To illustrate by way of example, one or more delay parameters, one or more throughput parameters, and/or one or more data transfer amount parameters of a provided node information array might depend upon the node and/or other computer to which they are provided, and/or upon data received from the node and/or other computer to which they are provided.

It is noted that, in various embodiments, a received node information array may include some or all of one or more node information arrays (e.g., some or all of one or more node information arrays maintained by another node and/or other computer).

In various embodiments, various node information array dispatch and receipt functionality discussed herein may be implemented via one or more software modules running remote from and/or at the node and/or other computer. Such software modules might, in various embodiments, be loaded onto the node and/or other computer during manufacture, sale, and/or activation, be transferred to the node and/or other computer from another node and/or other computer (e.g., via proximity connection and/or via the Internet), and/or be distributed via peer-to-peer.

Operation Determination Operations

According to various embodiments of the present invention, the node and/or other computer may make one or more determinations regarding its operation in view of some or all of one or more maintained and/or received node information arrays. For example, the node and/or other computer might make one or more determinations regarding its operation in view of some or all of one or more maintained local node information arrays and/or some or all of one or more received remote node information arrays. Such functionality may be implemented in a number of ways.

It is noted that, in various embodiments, one or more received node information arrays taken into account in performing a particular operational determination might be provided by one or more nodes and/or other computers involved in the operation for which determination is being made. For instance, in the case where the operation for which determination is being made is download from another node and/or other computer, the one or more received node information arrays taken into account may be ones provided by that node and/or other computer.

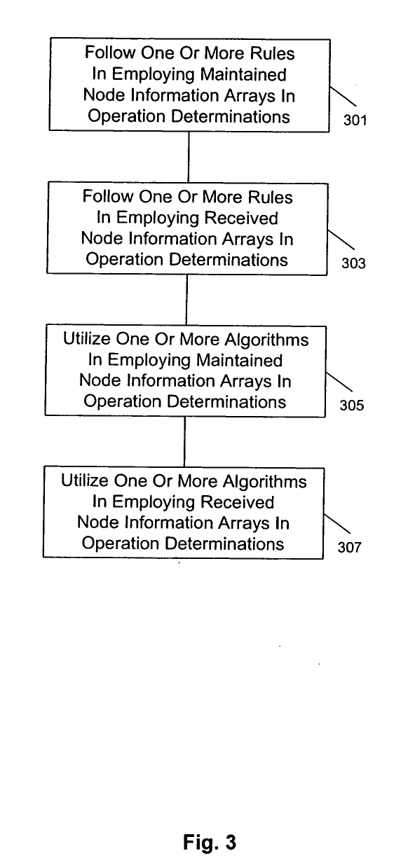

With respect to FIG. 3 it is noted that, according to various embodiments of the present invention, one or more rules may be followed in employing maintained and/or received node information arrays in making one or more operation determinations (steps 301, 303).

For example, a rule might be followed that specifies that download (e.g., peer-to-peer download) from another node and/or other computer should only occur in the case where one or more maintained node information arrays contain one or more communication access type parameter indications of WiFi being available, and one or more maintained node information arrays contain one or more power source information parameter indications of charging via automotive and/or wall outlet power.

As another example, a rule might be followed that specifies that download from another node and/or other computer should only occur in the case where one or more node information arrays received from that other node and/or other computer contain one or more delay parameter indications of less than one or more specified values, and one or more node information arrays received from that other node and/or other computer contain one or more throughput parameter indications of greater than one or more specified values.

As yet another example, a rule might be followed that specifies that download from another node and/or other computer should only occur in the case where one or more maintained node information arrays contain one or more communication access type parameter indications of WiFi being available, one or more maintained node information arrays contain one or more power source information parameter indications of charging via automotive and/or wall outlet power, one or more node information arrays received from that other node and/or other computer contain one or more delay parameter indications of less than one or more specified values, and one or more node information arrays received from that other node and/or other computer contain one or more throughput parameter indications of greater than one or more specified values.

As a further example, a rule might be followed that specifies that upload (e.g., peer-to-peer upload) to another node and/or other computer should only occur in the case where one or more maintained node information arrays contain one or more communication access type parameter indications of WiFi being available, one or more maintained node information arrays contain one or more power source information parameter indications of charging via automotive and/or wall outlet power, one or more maintained node information arrays contain one or more time and/or date parameter indications of it being nighttime, and one or more maintained node information arrays contain one or more usage status parameter indications of being idle. Such a rule might, for instance, be employed in the case where it was desired to earn peer-to-peer and/or download credits during the nighttime.

As another example, a rule might be followed that specifies that upload to another node and/or other computer should only occur in the case where one or more node information arrays received from that other node and/or other computer contain one or more delay parameter indications of less than one or more specified values, and one or more node information arrays received from that other node and/or other computer contain one or more throughput parameter indications of greater than one or more specified values.

As yet another example, a rule might be followed that specifies that upload to another node and/or other computer should only occur in the case where one or more maintained node information arrays contain one or more communication access type parameter indications of WiFi being available, one or more maintained node information arrays contain one or more power source information parameter indications of charging via automotive and/or wall outlet power, one or more maintained node information arrays contain one or more time and/or date parameter indications of it being nighttime, one or more maintained node information arrays contain one or more usage status parameter indications of being idle, one or more node information arrays received from that other node and/or other computer contain one or more delay parameter indications of less than one or more specified values, and one or more node information arrays received from that other node and/or other computer contain one or more throughput parameter indications of greater than one or more specified values.

As an additional example, a rule might be followed that specifies that receipt (e.g., involving Really Simple Syndication (RSS)) of a podcast corresponding to a particular region (e.g., a weather report podcast for that region) from another node and/or other computer (e.g., a server and/or via peer-to-peer) should only occur in the case where one or more maintained node information arrays contain one or more location parameter indications of a network identifier corresponding to that region.

As a further example, a rule might be followed that specifies that receipt of a podcast corresponding to a particular region from another node and/or other computer should only occur in the case where one or more node information arrays received from that other node and/or other computer contain one or more delay parameter indications of less than one or more specified values, and one or more node information arrays received from that other node and/or other computer contain one or more throughput parameter indications of greater than one or more specified values.

As another example, a rule might be followed that specifies that receipt of a podcast corresponding to a particular region from another node and/or other should only occur in the case where one or more maintained node information arrays contain one or more location parameter indications of a network identifier corresponding to that region, where one or more node information arrays received from that other node and/or other computer contain one or more delay parameter indications of less than one or more specified values, and one or more node information arrays received from that other node and/or other computer contain one or more throughput parameter indications of greater than one or more specified values.

As yet another example, a rule might be followed that specifies that media consumption (e.g., playing of a podcast) should be performed (e.g., automatically) in the case where one or more maintained node information arrays contain one or more power source information parameter indications of power source level being greater than 50%, and one or more maintained node information arrays contain one or more usage status parameter indications of car kit use.

As a further example, a rule might be followed that specifies that media consumption should be performed (e.g., automatically) in the case where one or more maintained node information arrays contain one or more power source information parameter indications of power source level being greater than 50%, one or more maintained node information arrays contain one or more usage status parameter indications of car kit use, and one or more maintained node information arrays contain one or more friendly node and/or other computer status parameter indications of no friendly nodes and/or other computers.

As an additional example, a rule might be followed that specifies that maintenance traffic (e.g., peer-to-peer maintenance traffic) should be reduced (e.g., automatically) in the case where one or more maintained node information arrays contain one or more communication access type parameter indications of only UMTS and/or GPRS being available, and one or more maintained node information arrays contain one or more power source information parameter indications of power source level being less than 50%. Such a rule might, for instance, specify that reduction of peer-to-peer maintenance traffic should be achieved via reducing number of ping requests sent and/or by reducing number of maintained ultrapeer connections.

As a further example, a rule might be followed that specifies that upload (e.g., peer-to-peer upload) of content of a particular sort (e.g., personal content such as, for instance, content for which the node and/or other computer is an originator) to another node and/or other computer should only occur in the case where one or more maintained node information arrays contain one or more communication access type parameter indications of WiFi being available, and one or more maintained node information arrays contain one or more power source information parameter indications of power source level being greater than 50%.

As another example, a rule might be followed that specifies that upload of content of a particular sort to another node and/or other computer should only occur in the case where one or more node information arrays received from that other node and/or other computer contain one or more delay parameter indications of less than one or more specified values, and one or more node information arrays received from that other node and/or other computer contain one or more throughput parameter indications of greater than one or more specified values.

As yet another example, a rule might be followed that specifies that upload of content of a particular sort to another node and/or other computer should only occur in the case where one or more maintained node information arrays contain one or more communication access type parameter indications of WiFi being available, one or more maintained node information arrays contain one or more power source information parameter indications of power source level being greater than 50%, one or more node information arrays received from that other node and/or other computer contain one or more delay parameter indications of less than one or more specified values, and one or more node information arrays received from that other node and/or other computer contain one or more throughput parameter indications of greater than one or more specified values.

As another example of a rule, a rule might be followed that specifies that search involving other nodes and/or other computers (e.g., peer-to-peer search) should be with respect to local nodes and/or other computers in the case where one or more maintained node information arrays contain one or more communication access type parameter indications of only Bluetooth being available, and one or more maintained node information arrays contain one or more power source information parameter indications of power source level being less than 50%. Such local nodes and/or other computes might, for instance be nodes and/or other computers that are members of a local area network of which the local node and/or other computer is a member, nodes and/or other computers in proximity connection range, and/or nodes and/or other computers accessible within a specified number of hops (e.g., Internet Protocol (IP) route hops).

As a further example, a rule might be followed that specifies that search involving other nodes and/or other computers should be with respect to local nodes and/or other computers in the case where one or more node information arrays received from one or more nodes and/or other computers considered for employment in searching contain one or more delay parameter indications of greater than one or more specified values, and one or more node information arrays received from those one or more nodes and/or other computers contain one or more throughput parameter indications of less than one or more specified values.

As an additional example, a rule might be followed that specifies that search involving other nodes and/or other computers should be with respect to local nodes and/or other computers in the case where one or more maintained node information arrays contain one or more communication access type parameter indications of only Bluetooth being available, one or more maintained node information arrays contain one or more power source information parameter indications of power source level being less than 50%, one or more node information arrays received from one or more nodes and/or other computers considered for employment in searching contain one or more delay parameter indications of greater than one or more specified values, and one or more node information arrays received from those one or more nodes and/or other computers contain one or more throughput parameter indications of less than one or more specified values.

As another example, a rule might be followed that specifies that search involving other nodes and/or other computers should not be limited to being with respect to only local nodes and/or other computers in the case where one or more maintained node information arrays contain one or more communication access type parameter indications of UMTS and/or GPRS being available, and one or more maintained node information arrays contain one or more power source information parameter indications of charging via automotive and/or wall outlet power.

As a further example, a rule might be followed that specifies that search involving other nodes and/or other computers should not be limited to being with respect to only local nodes and/or other computers in the case where one or more node information arrays received from one or more nodes and/or other computers considered for employment in searching contain one or more delay parameter indications of less than one or more specified values, and one or more node information arrays received from those one or more nodes and/or other computers contain one or more throughput parameter indications of greater than one or more specified values.

As an additional example, a rule might be followed that specifies that search involving other nodes and/or other computers should not be limited to being with respect to only local nodes and/or other computers in the case where one or more maintained node information arrays contain one or more communication access type parameter indications of UMTS and/or GPRS being available, one or more maintained node information arrays contain one or more power source information parameter indications of charging via automotive and/or wall outlet power, one or more node information arrays received from one or more nodes and/or other computers considered for employment in searching contain one or more delay parameter indications of less than one or more specified values, and one or more node information arrays received from those one or more nodes and/or other computers contain one or more throughput parameter indications of greater than one or more specified values.

It is noted that, according to various embodiments of the present invention, one or more search plugins may be employed. A number of search plugins may, in various embodiments, be available. For example, media search plugins (e.g., plugins for searching for audio, video, and/or images), text search plugins, plugins for Internet search (e.g., for searching the world wide web), plugins for vicinity search (e.g., for searching for nearby amenities such as, for instance, restaurants, lodging, entertainment, stores, repairs, and/or medical services), plugins for search of data of the node and/or other computer (e.g., for searching productivity data such as organizer, word processing, spreadsheet, and/or presentation data) and/or peer-to-peer search plugins (e.g., local peer-to-peer network search plugins and/or global peer-to-peer network search plugins) might be available. It is noted that, in various embodiments, one or more available plugins may make use of one or more search engines (e.g., Internet search engines and/or vicinity search engines).

Communication with a search engine might, for example, involve for Hypertext Transfer Protocol (HTTP) communication, SOAP, JMS, RMI, RPC, sockets, and/or pipes. It is noted that, in various embodiments, search plugins making use of search engines may make use of single search engines and/or multiple search engines. To illustrate by way of example, an Internet search plugin might make use of a single Internet search engine (e.g., Google), and/or an Internet search plugin might make use of multiple Internet search engines (e.g., Google and Yahoo). It is noted that searched data of the node and/or other computer might, in various embodiments, be stored an a database remote form and/or at the node and/or other computer.

In various embodiments, in following one or more rules (e.g., of the sort discussed above) one or more search plugins may be employed, and/or one or more rules may specify the use of one or more search plugins. To illustrate by way of example, the following of a rule specifying that search involving other nodes and/or other computers should be with respect to local nodes and/or other computers might involve use of a plugin for local peer-to-peer network search, and/or the rule might specify use of such a plugin. To further illustrate by way of example, the following of a rule specifying that search involving other nodes and/or other computers should not be limited to being with respect to only local nodes and/or other computers might involve use of a plugin for global peer-to-peer network search, and/or the rule might specify use of such a plugin.

It is noted that, according to various embodiments of the present invention, rules might, for example, be specified by a user, a manufacturer, and/or a system administrator. Such specification might, for instance, involve employment of a GUI and/or other interface.

It is further noted that, in various embodiments, rules may be made available in a number of ways. For example, one or more rules might be loaded onto the node and/or other computer during manufacture, sale and/or activation, be transferred to the node and/or other computer from another node and/or other computer (e.g., via proximity connection and/or via the Internet), and/or be distributed via peer-to-peer.

It is additionally noted that, in various embodiments, in addition to or as an alterative to following one or more rules in making one or more operation determinations, one or more algorithms may be employed in making one or more operation determinations. For example, one or more algorithms might be utilized in employing maintained and/or received node information arrays in making one or more operation determinations (steps 305, 307). Such algorithms might, for instance, be made available in a manner analogous to that discussed above with respect to rules.

Various of the exemplary rules discussed herein specify that operation performance be dependent on communication access type parameter indication of a particular type of communication being available. Such a rule might, for instance, be employed in the case where the node and/or other computer is capable of both faster connection (e.g., via WiFi) and slower connection (e.g., via Bluetooth), and act so that an operation (e.g., upload and/or download) does not occur in the case where only the slower connection is available.

Moreover, various of the exemplary rules discussed herein specify that operation performance be dependent on delay parameter indication of less than one or more specified values. Such a rule might, for instance act so that an operation (e.g., upload and/or download) is performed in conjunction with a node and/or other computer offering a lesser delay instead of a node and/or other computer offering a greater delay.

It is noted that, in various embodiments, fees (e.g., fees associated with data receipt and/or transmission) might be taken into account in making one or more operation determinations. Fee information might, for example, take into account factors such as location and/or time of day. Fee information might, for example, be specified by a user, a manufacturer, and/or a system administrator (e.g., via a GUI). As another example, fee information might be received from another node and/or other computer (e.g., a server).

It is additionally noted that, in various embodiments, amount of data to be transmitted and/or received (e.g., file size and/or number of files) might be taken into account in making one or more operation determinations. To illustrate by way of example, one or more rules and/or algorithms might act such that small files can be downloaded even when throughput is poor (e.g., below a specified threshold) and/or only slower access is available (e.g., Bluetooth), but that larger files can only be downloaded in the case where throughput is good (e.g., above a specified threshold) and/or faster access is available (e.g., WiFi). Both amount of data to be transmitted and/or received, and power source information might, as another example, be taken into account in rules and/or algorithms. To illustrate by way of example, one or more rules and/or algorithms might act such that data transmission and/or receipt not be performed when throughput is poor and power source level is low (e.g., below a specified threshold). Such operation might, for instance, prevent wasting of power source energy when there is not much left.

It is noted that, in various embodiments one or more rules and/or algorithms regarding data transfer with another node and/or other computer (e.g., upload to another node and/or other computer, and/or download from another node and/or other computer) might act such that data transfer preference is given to another node and/or other computer over other nodes and/or other computers in certain cases. Such cases might, for example, include the case where that node and/or other computer is a mobile node and/or other computer, and/or it is experiencing limited resources (e.g., a slow link and/or a low power source level). Awareness of such circumstance (e.g., being a mobile node and/or other computer, and/or experiencing limited resources) might, for example, be via one or more node information arrays received from the node and/or other computer experiencing such circumstance. The functionality by which preference could be given might be implemented in a number of ways. For example, in the case where a queue is employed, a higher priority spot in the queue might be granted. As another example, or a different serving policy might be employed.

It is further noted that, in various embodiments, one or more rules and/or algorithms may be employed that correspond to upload and/or download of a particular type of data (e.g., audio files such as, for instance, MP3 files).

Moreover, in various embodiments, various operation determination functionality discussed herein may be implemented via one or more software modules running remote from and/or at the node and/or other computer. Such software modules might, in various embodiments, be loaded onto the node and/or other computer during manufacture, sale, and/or activation, be transferred to the node and/or other computer from another node and/or other computer (e.g., via proximity connection and/or via the Internet), and/or be distributed via peer-to-peer.

Calculation and Prediction Operations

According to various embodiments of the present invention, one or more calculations regarding node information arrays may be performed and/or one or more predictions regarding future node information arrays may be made. Such functionality may be implemented in a number of ways.

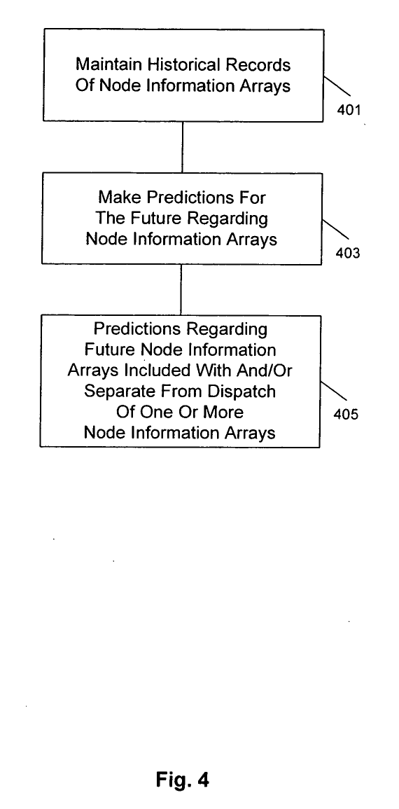

With respect to FIG. 4 it is noted that, for example, a node and/or other computer maintaining one or more node information arrays might maintain historical records of those node information arrays (step 401). Accordingly, for instance, the node and/or other computer might maintain past versions of those node information arrays and/or might maintain record of changes over time to those node information arrays. Such historical records might be employed in a number of ways.

For example, included with and/or separate from dispatch of one or more maintained node information arrays (e.g., of the sort discussed above) might be some or all of one or more historical records corresponding to those node information arrays. Such provision might, for instance, be performed in a manner analogous to that discussed above. For instance, one or more custom headers might, perhaps in a manner analogous to that discussed above, be employed.

As another example, the node and/or other computer maintaining the historical records might employ the historical records in making predictions for the future regarding the node information arrays that it is maintaining (step 403). Such functionality may be implemented in a number of ways. It is noted that, in various embodiments, a node information array including corresponding historical records might be referred to as an extended node information array.

The node and/or other computer might, for instance, employ the historical records in determining averages and/or making predictions for various parameters. In various embodiments, such averages and/or predictions might, for instance, be time-based.

The node and/or other computer might, for example, calculate average throughput, calculate average throughput with respect to hours of the day, predict the hours of the day and/or portions of the day that it offers highest throughput, predict the hours of the day and/or portions of the day that it is charged, predict time to elapse to next offering of high throughput, and/or predict time to elapse to next charging. To illustrate by way of example, the node and/or other computer might predict that it offers highest throughput 14 out of 24 hours of the day, predict that it offers highest throughput between 7 a.m. and 11 a.m., and between 8 p.m. and midnight, predict that it is charged eight out of 24 hours of the day, predict that it is charged between 1 a.m. and 6 a.m., and/or calculate that 6 hours are to elapse to next predicted offering of high throughput. It is noted that, in various embodiments, one or more statistical analyses, computational techniques, and/or computer learning techniques might be employed.

According to various embodiments, performed calculations regarding node information arrays and/or made predictions regarding future node information arrays might be included with and/or separate from dispatch of one or more maintained node information arrays (step 405). Such provision might, for instance, be performed in a manner analogous to that discussed above. For example, one or more custom headers might, perhaps in a manner analogous to that discussed above, be employed. To illustrate by way of example, one or more “m-hi_throughput” headers might be employed to convey one or more times to elapse to next offerings of high throughput.

A node and/or other computer that receives such historical records might, for instance, perform one or more calculations regarding node information arrays, and/or make one or more predictions regarding future node information arrays. Such calculations and/or predictions might, for instance be performed in a manner analogous to that discussed above. Moreover, a node and/or other computer that has so received such historical records and that has so performed one or more calculations and/or made one or more predictions, and/or a node and/or other computer that has so received such calculations and/or predictions might employ the calculations and/or predictions in a number of ways.

For example, in the case a node and/or other computer found that one or more rules and/or algorithms indicated that an operation (e.g., an upload and/or download) was not to be performed and/or should not be performed, the node and/or other computer might, for instance, employ calculations and/or predictions in determining circumstances under which the operation could be performed and/or should be performed. Such circumstances under which the operation could and/or should be performed might, for instance, be the operation being performed at a different time.

It is noted that, in various embodiments, various calculation and prediction functionality discussed herein may be implemented via one or more software modules running remote from and/or at a node and/or other computer. Such software modules might, in various embodiments, be loaded onto the node and/or other computer during manufacture, sale, and/or activation, be transferred to the node and/or other computer from another node and/or other computer (e.g., via proximity connection and/or via the Internet), and/or be distributed via peer-to-peer.

Search Operations

According to various embodiments of the present invention, the node and/or other computer may perform various operations relating to search. Such functionality may be implemented in a number of ways. Various search functionality was discussed above, and further discussion of search functionality will now be provided.

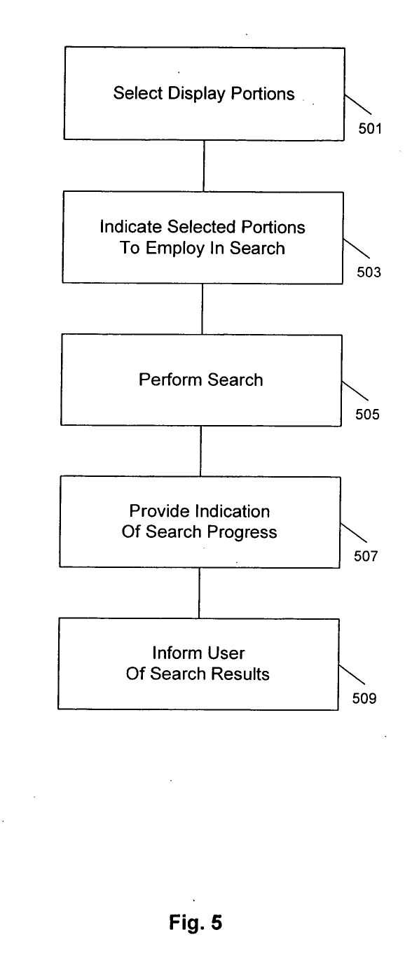

For example, with respect to FIG. 5 it is noted that, according to various embodiments of the present invention a user of the node and/or other computer may be able to select one or more portions of a presented display (e.g., display presented via a GUI and/or other interface) (step 501). Such might, for example, be indicated by the user via a GUI and/or other interface.

The user might, for instance, be able to select one or more displayed items and/or areas. Such areas might, for example, be areas delineated by rectangles and/or other geometric shapes. As another example, such areas might be delineated free-form by the user. The user might, in various embodiments be able to select any portion of the presented display. In various embodiments, selected portions might, for example, include, text, icons, images, windows, metadata, widgets (e.g., buttons), graphics (e.g., background graphics), and/or portions thereof. In various embodiments, a selection tool (e.g., a GUI and/or other interface selection tool) might be provided to the user for performing selection. The selection tool might, in various embodiments, act to determine one or more types corresponding to selection by the user. To illustrate by way of example, the selection tool might act to determine that the user selected text and/or graphics.

The user might, in various embodiments, be able to indicate that one or more selected portions should be employed in search (step 503). Such functionality may be implemented in a number of ways. For example, the presented display might provide an indication to which the user can provide the selections (e.g., via dragging such as, for instance, GUI dragging). Such an indication might, for instance, be an icon, text, and/or a dedicated display area. Such an indication might, for example, visually convey the notion of search (e.g., via text conveying the notion of search and/or icon conveying the notion of search). To illustrate by way of example, in various embodiments the user might be able to drag one or more selected portions to an icon of binoculars, the word “search”, and/or a dedicated display area. Responsive to the user's action (e.g., dragging), appropriate search taking into account the indicated portions might, for example, be performed (step 505).

Selected portions might, in various embodiments, be employable in a number of types of search (e.g., of the sort discussed above such as, for instance, Internet search, vicinity search, and/or peer-to-peer search). In various embodiments, the user might be able to indicate (e.g., via a GUI and/or other interface) that one or more types of search to be performed. It is noted that, in various embodiments, search might involve the use of one or more plugins (e.g., of the sort discussed above).

It is noted that, in various embodiments, search may be performed in the background (e.g., visually hidden from the user), with the user perhaps being provided with indication of search progress (e.g., via a GUI and/or other interface) (step 507). Indication of progress might, in various embodiments, be only shown in response to user request (e.g., via a GUI and/or other interface) for such. Background functionality might, for example, allow the user to perform other tasks while search was taking place.

It is further noted that, in various embodiments, one or more operations may be performed in view of selection type (e.g., text or graphics). For example, selected text and/or metadata incorporated in a graphics file might be directly employed in search. As another example, in the case of selection of other than text (e.g., media, productivity data, and/or software) metadata associated with that which is selected (e.g., metadata associated with a selected image and/or selected music) might be employed in search. As yet another example, the results of optical character recognition (OCR) might be employed in search (e.g., the result of OCR on an image including a depiction of text). As a further example, search might seek results bearing other than textual similarity to the selected. For instance, search might seek results of similar graphical patterns and/or color schemes where the selected is graphical, and/or search might seek results of similar sound patterns where the selected is audio. It is noted that, in various embodiments, the user might be able to (e.g., via a GUI and/or other interface) provide indications of how operations should be performed in view of selection type.

With search having been performed, the node and/or other computer might, for instance, inform the user of the results (step 509). A GUI and/or other interface might, for instance, be employed in so informing the user. In various embodiments, the node and/or other computer might, once search is complete, display an indication (e.g., a sound and/or image) to indicate that search is complete, and not provide search results to the user until such is requested by the user (e.g., via a GUI and/or other interface).

It is noted that, in various embodiments, one or more maintained and/or received node information arrays may be taken into account in such search. For example, maintained and/or received node information arrays might be considered in choosing one or more search plugins to be employed. As another example, maintained and/or received node information arrays might be employed in determining what is to be sought in search. To illustrate by way of example, suppose that the user selected and dragged to an appropriate indication (e.g., search icon) an image of a island sunset with large waves. In the case where maintained and/or received node information arrays indicated the user of the node and/or other computer to be on vacation, search might be vicinity search for surfing opportunities near the location of the node and/or other computer. On the other hand, in the case where maintained and/or received node information arrays indicated the user of the node and/or other computer to be at work at a financial services job, search might be Internet search for news stories about Tsunami damage to the island depicted in the image.

It is noted that, in various embodiments, plugin choice may be automatic. For example, the node and/or other computer might automatically choose one or more plugins based on various criteria such as, for instance, context of the node and/or other computer. Such context might, for example, include one or more factors discussed above (e.g., location of the node and/or other computer). It is further noted that, in various embodiments, the node and/or other computer might provide to its user (e.g., via a GUI and/or other interface) one or more suggestions regarding one or more plugins to be employed, and the user may indicate (e.g., via a GUI and/or other interface) plugin choice. Moreover, in various embodiments the user may indicate (e.g., via a GUI and/or other interface) plugin choice without having received any suggestions from the node and/or other computer.

In various embodiments, the node and/or other computer might perform one or more search result management operations. Such operations might, for instance, include sorting, saving searches, and/or combining search results from different searches.

As discussed above, according to various embodiments of the present invention, vicinity search may be performed. For example, in various embodiments the node and/or other computer may receive from its user indication (e.g., terms, criteria, and/or selections (e.g., selected portions of a presented display)) to be employed in vicinity search. Such indication might, for instance, be received via a GUI and/or other interface.

It is noted that, in various embodiments, map display may be employed by the node and/or other computer in informing the user of results of such search. Such functionality may be implemented in a number of ways. It is noted that, in various embodiments, vicinity search may make use of electronic yellow pages, vicinity search engines, and/or the like.

For example, in various embodiments the node and/or other computer might come to possess geographical data (e.g., geographical coordinates and/or street addresses) corresponding to search results (e.g., amenities of the sort discussed above such as, for instance, restaurants and/or medical services). Such geographical data might be received in a number of ways. For example, such geographical data might be included with search hits. As another example, the node and/or other computer might act to receive from an accessible store and/or from another node and/or other computer geographical data corresponding to search hits.

Possessing geographical data corresponding to search hits the node and/or other computer might, for instance, employ the geographical data in presenting search hits to the user. Such functionality may be implemented in a number of ways.

For example, in various embodiments the node and/or other computer might come to possess map data for one or more areas of the world corresponding to the geographical data corresponding to the search hits. The node and/or other computer might, for instance retrieve the map data from an accessible store and/or from another node and/or other computer. The node and/or other might, in various embodiments, cache map data. Accordingly, in various embodiments the node and/or other computer might attempt to retrieve required map data from cache before attempting to retrieve it from another source. It is noted that, in various embodiments, receipt of map data by the node and/or other computer might involve the use of communication of the sort discussed above (e.g., SOAP, JMS, RMI, RPC, sockets, and/or pipes). It is further noted that, in various embodiments, one or more plugins might be employed by the node and/or other computer in coming to posses map data.

Possessing the appropriate map data, the node and/or other computer might, for example, present map display of one or more of the search hits to its user. Such functionality might be implemented in a number of ways. For example, the node and/or other computer might display one or more maps to its user wherein one or more search hits are conveyed via one or more indicators (e.g., icons) placed at map locations corresponding to geographical information corresponding to search hits. To illustrate by way of example, the node and/or other computer might place an indicator corresponding to a search hit on a displayed map at a location on the map corresponding to geographical coordinates for the search hit.

It is noted that, in various embodiments, the node and/or other computer might allow for the manipulation of map view (e.g., zooming and/or scrolling). Accordingly, for instance, the user might be able to request manipulation of map view via a GUI and/or other interface. It is noted that, in various embodiments, the node and/or other computer might not place indicators corresponding to one or more search hits under certain circumstances. For instance, the node and/or other computer might, in various embodiments, not place one or more such indicators at one or more certain zoom levels. The user may, according to various embodiments, be able to select (e.g., via a GUI and/or other interface, and/or by pressing keyboard and/or keypad buttons) one or more map-displayed indicators corresponding to search hits. For example, the map view might present a number for each displayed search hit, and the user might be able to press a number on the keypad to receive additional information regarding the corresponding search hit. The user might, for instance, be presented with one or more GUI elements allowing her to choose to initiate a telephone call to a telephone number relating to a selected search hit (e.g., in the case where the search hit was for a restaurant, the user might be able to choose to initiate a telephone call to the restaurant).

It is noted that, in various embodiments, the node and/or other computer might automatically select a zoom level that allowed for presentation on a single map display of multiple search hit indicators. For instance, a zoom level might be automatically selected that allowed for presentation on a single map display of the search hit indicators corresponding to all hits yielded by a search. Such functionality might be implemented in a number of ways. For example, a zoom level that provided the closest-in possible zoom while still showing a large enough geographical region for all appropriate search hit indicators to be displayed might be automatically selected. Such functionality might, in various embodiments, be implemented so that some or all of the search results are associated with geographical coordinates. In various embodiments, based on this information, the results may be matched with the zoom level in which all selected results (e.g., the first ten hits) can be shown.

Such selection might result in a number of operations being performed. For instance, the node and/or other computer might provide to the user (e.g., via a GUI and/or other interface) various information regarding a search hit corresponding to a selected indicator (e.g., textual description, address information, contact information such as telephone numbers and/or email addresses, review information, and/or travel information such as directions). In various embodiments, the user might be able to switch between map views and search hit information views.

In various embodiments indicators placed at map locations corresponding to geographical information corresponding to search hits could each convey one of digits 0-9, and the user might be able to press the keypad button for the digit conveyed by an indicator to receive additional information regarding the corresponding search hit. To illustrate by way of example, in the case where map view presented indicators for three search hits, an indicator corresponding to a first of the search hits might convey the digit “0”, an indicator corresponding to a second of the search hits might convey the digit “3”, and an indicator corresponding to a third of the search hits might convey the digit “4”. The user might then be able to receive additional information regarding the first of the search hits by pressing “0” on the keypad, might be able to receive additional information regarding the second of the search hits by pressing “3” on the keypad, and/or might be able to receive additional information regarding the third of the search hits by pressing “4” on the keypad.

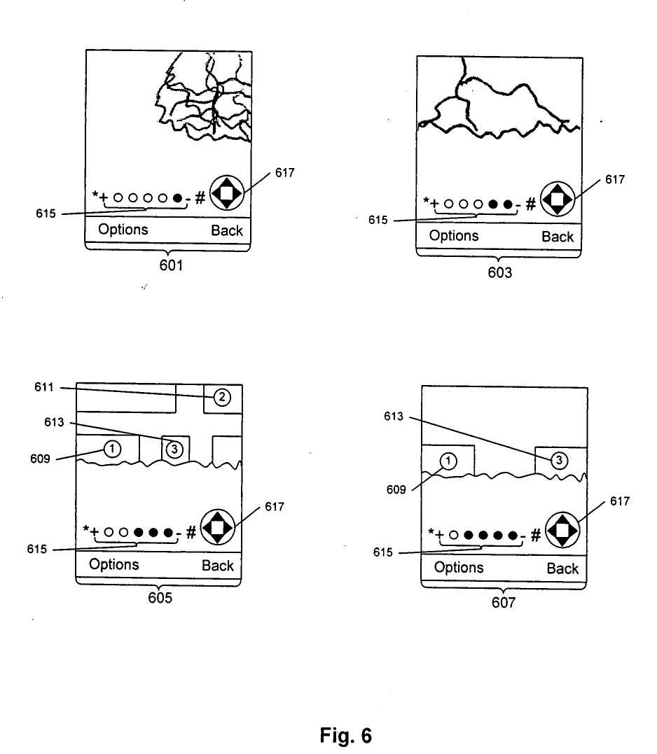

Shown in FIG. 6 are exemplary displayed maps 601-607 corresponding to different zoom levels. Also shown in FIG. 6 are exemplary displayed search hit indicators 609-613 placed at map locations corresponding to geographical data for the hits. Further shown in FIG. 6 are zoom indicator 615 and scroll indicator 617.

It is noted that search hit indicator 609 conveys the digit “1”, search hit indicator 611 conveys the digit “2”, and search hit indicator 613 conveys the digit “3”. In various embodiments, the user might be able to receive additional information regarding the search hit corresponding to search hit indicator 609 by pressing “1” on the keypad, might be able to receive additional information regarding the search hit corresponding to search hit indicator 611 by pressing “2” on the keypad, and/or might be able to receive additional information regarding the search hit corresponding to search hit indicator 613 by pressing “3” on the keypad. It is noted that, in various embodiments, the user might be able to request zoom using keypad keys (e.g., “*” and “#”). To illustrate by way of example, the user might be able to request zoom-in by pressing “*” on the keypad and/or might be able to request zoom-out by pressing “#” on the keypad.

It is noted that, in various embodiments, map display functionality might be implemented in a manner employing Open Graphics Library (OpenGL), and/or Nokia Scalable Vector Graphics (SVG). It is further noted that, in various embodiments, map display functionality may be implemented in a manner employing one or more SVG viewer software modules. It is additionally noted that, in various embodiments, map data may be in compressed and/or uncompressed SVG format.

In various embodiments, map display might present, via search hit indicators (e.g., of the sort discussed above), only a single search plugin's search results. It is further noted that, in various embodiments, searching may be performed by multiple search plugins (e.g., plugins making use of different search engines), and/or search results yielded by multiple search plugins may be presented, via search hit indicators (e.g., of the sort discussed above), on a single map display. Such functionality might, in various embodiments, involve search result caching. It is noted that, in various embodiments, yellow pages search might be performed (e.g., employing one or more yellow pages search plugins). Moreover, in various embodiments, search results from different plug-ins might be shown in display separated by tabs, and/or might be shown such that the results can be seen simultaneously in a scrollable view. Such a scrollable view might, in various embodiments, be separated by plugin information.

As an illustrative example, three search plugins might be employed and search hit indictors “0” through “6” might be presented on a single map display, with search hit indicators “0” and “4” corresponding to the search results of the first of the search plugins, search hit indictors “1” and “2” corresponding to the search results of the second of the search plugins, and the remaining search hit indicators corresponding to the search results of the third of the search plugins. Search results from different plugins might, in various embodiments, be separated (e.g., by colors). It is further noted that, in various embodiments, search results from a first search plugin may be displayed first, and the user might, for instance, be able to request search results from a second plugin. Accordingly, in various embodiments the user might be able to utilize search results from the first search plugin and cache the results. Moreover, in various embodiments when viewing the results of the second plugin, search results from the first plugin might be shown on the map display simultaneously with results from the second plugin, and/or the user might be able to request display of search results of the first plugin (e.g., by pressing a button on the node and/or other computer, and/or via a softkey of the node and/or other computer).

It is noted that, in various embodiments, certain keyboard and/or keypad buttons of the node and/or other computer might be reserved for hits found by one or more particular search plugins. To illustrate by way of example, buttons “0”-“3” might be reserved for hits found by a first search plugin, buttons “4”-“6” might be reserved for hits found by a second search plugin, and buttons “7”-“9” might be reserved for hits found by a third search plugin. To further illustrate by way of example, buttons “0”-“3” might be reserved for hits found by a first or second search plugin, buttons “4”-“6” might be reserved for hits found by a third or fourth search plugin, and buttons “7”-“9” might be reserved for hits found by a fifth or sixth search plugin. It is noted that, in various embodiments, the first plugin might reserve all numbers “0”-“9” for its search results. The second plugin might, in various embodiments, then have its search results separated from the search results of the first plugin (e.g., by color), and/or the user might be able to hop between the results of the first plugin and the results of the second plugin (e.g., via a two-key combination). It is noted that, in various embodiments, the situation might occur where a first plugin might yield the result desired by the user, and the results of a second plugin might not need to be displayed at all. Such might occur, for instance, in the case where extensive hits were yielded by the first plugin.

It is noted that, in various embodiments, display of search hit indicators might be such that the corresponding one or more search plugins that provided a hit can be determined by a user, and/or display of search hit indicators might be such that a user can distinguish between search hit indicators corresponding to different search plugins. To illustrate by way of example, displayed search indicators might convey (e.g., via image and/or color) their corresponding search plugins. Accordingly, for instance, search hit indicators corresponding to search employing a plugin for Google might convey a “G” character, while search hit indicators corresponding to search employing a plugin for Yahoo might convey a “Y” character. To further illustrate by way of example, search hit indicators corresponding to search employing a first plugin might be colored orange while search hit indicators corresponding to search employing a second plugin might be colored blue, with the displayed colors perhaps lacking permanent correlations to particular plugins.

As noted above, in various embodiments the search results of multiple search plugins may be presented, via search hit indicators, on a single map display. It is further noted that, in various embodiments, GUI tabbed display and/or multiple displays might alternately or additionally be employed to separately convey the results of search performed by multiple search plugins.

To illustrate by way of example, a map display viewable by user-selection of a first GUI tab might display only those search hit indicators corresponding to search results of a first search plugin, a map display viewable by user-selection of a second GUI tab might display only those search hit indicators corresponding to search results of a second search plugin, and a map display viewable by user-selection of a third GUI tab might display only those search hit indicators corresponding to search results of a third search plugin.

Additionally, it is noted that, in various embodiments, functionality might alternately or additionally be implemented wherein GUI tabbed display and/or multiple displays are employed such that one or more map displays (e.g., viewable by GUI tab selection) present, via search hit indicators, the search results of multiple search plugins.

As discussed herein, selection of search plugins to be employed may, in various embodiments, take into account contextual information (e.g., retrieved from maintained and/or received node information arrays). Accordingly it is noted that, in various embodiments, search results of multiple search plugins, selected in view of contextual information, might be presented on a single map display via search hit indicators.

As an illustrative example of various functionality discussed herein, in the case where the user did not know the phone number of a shop that was to be telephoned, the user might employ the node and/or other computer in performing search, with the user providing to the node and/or other computer (e.g., via a GUI and/or other interface) the shop name and/or the city where the shop was located. The node and/or other computer might perform an appropriate search, with the node and/or other computer employing two search plugins, each plugin making use of a different search engine.

A tabbed GUI display for map display of the sort discussed above might be employed by the node and/or other computer. Employment of the tabbed GUI display might be such that search hit indicators corresponding to search results of the first plugin were to be presented in a map display viewable by user-selection of a first tab, while search results of the second plugin were to be presented in a map display viewable by user-selection of a second tab. It might turn out to be the case that the first of the plugins yielded a hit for the shop, while the second plugin did not. The user might then make use of the hit yielded by the first plugin. It is noted that, in various embodiments, one example of contextual information might be that the search results from the plugin which yields the most hits and/or yields the most information (e.g., the most relevant information) are displayed first. Accordingly, for instance, the user might be saved from having to select the correct tab to view desired hits. It is noted that, in various embodiments, in the case where a first plugin does not find any hits, but a second plugin finds one or more hits, the node and/or other computer might display the hits from the second plugin.

In various embodiments the user might, for example, select the tab corresponding to hits from the first plugin, press a button on the keypad of the node and/or other computer corresponding to the search hit indicator corresponding to the shop, and be presented with one or more GUI elements allowing the user to choose to initiate a telephone call to the shop. With the user indicating a desire to make the call, the node and/or other computer could initiate the call (e.g., via GSM or using Voice Over Internet Protocol (VOIP) over a data network).

In various embodiments, the user may be presented with one or more telephone numbers to call, one or more email addresses to send email, and/or one or more Universal Resource Locators (URLs) for webpages to browse. Accordingly, in various embodiments, the user may receive various types of search results, and/or may be presented search results in various ways. It is further noted that, in various embodiments, the node and/or other computer may query the user as to whether some or all of such found information (e.g., one or more telephone numbers) should be added to an accessible store of the node and/or other computer. For example, the node and/or other computer might query the user as to whether some or all of such found information should be added to contacts of the node and/or other computer.

Such functionality might be implemented in a number of ways. For instance, a separate GUI window might be opened wherein the use could select whether or not addition should occur. In various embodiments, in the case where the user indicates that addition should occur, relevant information (e.g., shop name, telephone number, webpage URL, email address, and/or geographical coordinates) might be stored (e.g., in contacts of the node and/or other computer) in a manner such that the data is stored in appropriate fields. To illustrate by way of example, shop name data might be stored in a shop name field in contacts, webpage URL might be stored in a URL field in contacts, and/or geographical coordinates might be stored in a geographical coordinates field in contacts.

It is noted that, in various embodiments, such stored information might be employed later in search. For example, one or more search plugins (e.g., for yellow pages and/or vicinity search) might search an accessible store of the node and/or other computer (e.g., contacts). Accordingly, for instance, in-device search might, in various embodiments be performed. To illustrate by way of example, a yellow pages search might employ one or more plugins that search an accessible store of the node and/or other computer such that yellow pages search is performed in a manner employing in-device search.

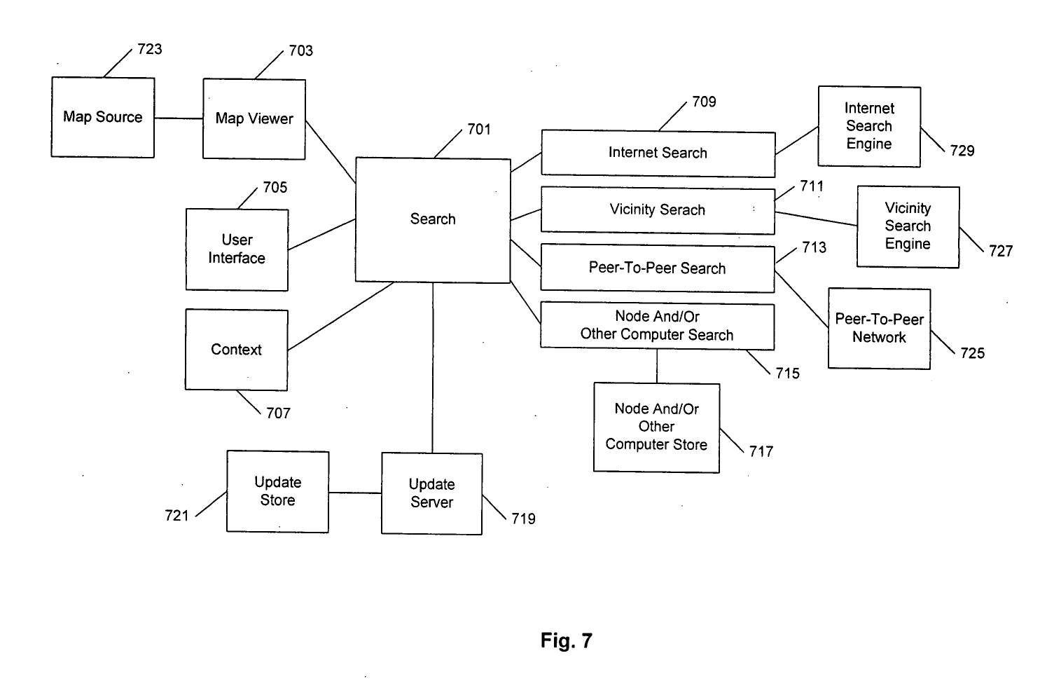

Shown in FIG. 7 is an exemplary architectural view according to various embodiments of the present invention including search software module 701, map viewer software module 703, user interface software module 705, context software module 707, Internet search plugin 709, vicinity search plugin 711, peer-to-peer search plugin 713, node and/or other computer search plugin 715, node and/or other computer store 717, update (e.g., software module update and/or search plugin update) server 719, update (e.g., software module update and/or search plugin update) store 721, map source (e.g., accessible store, and/or node and/or other computer) 723, peer-to-peer network 725, vicinity search engine 727, and Internet search engine 729. Communication among shown elements might, for instance, be performed in one or more manners discussed above.

Search software module 701 might, for example, be involved in the performance of one or more search operations discussed above. Map viewer software module 703 might, for example, be involved in the performance of one or more map display operations discussed above. Map source 723 might, for example, be a source for retrieval of map data (e.g., as discussed above). User interface software module 705 might, for example, be involved in the performance of one or more user interface operations discussed above.

Context software module 707 might, for instance, be involved in the performance of one or more context-related operations discussed above. For example, context software module 707 might be involved in the performance of one or more node information array maintenance operations (e.g., monitoring location, monitoring communication signal quality, monitoring usage status, and/or ascertaining parameters regarding data transfer), and/or in the performance of one or more operation determination operations (e.g., following one or more rules, and/or employing one or more algorithms). It is noted that, in various embodiments, context software module 707 might be involved in performance of one or more plugin choice operations discussed above. It is further noted that, in various embodiments, one or more operations not involving node information arrays might be performed (e.g., by context software module 707) that are analogous to one or more operations discussed above regarding node information arrays (e.g., monitoring, ascertaining, following one or more rules, and/or employing one or more algorithms).

Plugins 709-715 might, for instance, operate as discussed above. Internet search plugin 709 might, for example, make use of Internet search engine 729. Vicinity search plugin 711 might, for example, make use of vicinity search engine 727. Peer-to-peer search plugin 713 might, for example, interact with peer-to-peer network 725. Node and/or other computer search plugin 715 might, for example, interact with node and/or other computer store 717. Node and/or other computer store 717 might, for instance, contain various data of the node and/or other computer such as productivity data and/or media.

Update server 719 and update store 721 might, for instance, act in the performance of updating one or more software modules and/or plugins. For example, update server 719 might retrieve a required update from update store 721 and provide it to the node and/or other computer (e.g., in a manner involving the use of SOAP, JMS, RMI, RPC, sockets, and/or pipes).

It is noted that, in various embodiments, search functionality (e.g., vicinity search functionality) may be in accordance with one or more maintained and/or received node information arrays. For example, one or more maintained and/or received node information arrays might be taken into account in selection of a search plugin to be employed by the node and/or other computer. It is noted that, in various embodiments employed search plugin (e.g., vicinity search plugin) might be dependent upon location and/or service area. For instance, one search plugin (e.g., vicinity search plugin) might be employed for a home service area while another search plugin (e.g., vicinity search plugin) might be employed for a roamed-to service area. The node and/or other computer might, in various embodiments, receive (e.g., via network connection) a plugin (e.g., a vicinity search plugin) for an area with entry into to that area (e.g., with roaming to that area, perhaps for a first time and/or with availability of a new plugin). Accordingly, in various embodiments geofencing functionality might be implemented.

In various embodiments employed search plugins might be dependent upon location such that in the case where the node and/or other computer is at a particular building and/or area, one or more search plugins corresponding to the building and/or area are employed and/or received. Such buildings and/or areas might, for example, include shopping locations (e.g., shopping malls and/or stores), restaurants, hotels, office buildings, factories, professional buildings, transport hubs (e.g., train stations, bus stations, and/or airports), parks, amusement areas, sports arenas, vacation areas, housing locations (e.g., apartment buildings and/or private homes), landmarks, supermarkets, liquor stores, theaters, fitness centers, hospitals, and/or schools. It is noted that, in various embodiments, the user may be able to select a different location that the user's current location. To illustrate by way of example, in the case where the user was staying in Tokyo but wanted to search something in London, United Kingdom, the user could (e.g., via a GUI and/or other interface provided by the node and/or other computer) select London. Responsive to such selection the node and/or other computer could, for instance, make searches using plugins available in London even though the present location was Tokyo. It is further noted that, in various embodiments, the user may define search levels (e.g., country level, city level, and/or street level).

As an illustrative example, in the case where the node and/or other computer was at a shopping mall, one or more plugins providing for searching of the mall might be employed and/or received. Such searching might, for instance, include searching the mall for particular stores and/or restaurants, searching the mall for classes of purchasable articles (e.g., electronics, sporting goods, toys, and/or women's clothing), searching the mall for particular purchasable articles (e.g., a particular book, a particular film, and/or a particular article of clothing), searching the mall for types of restaurant food (e.g., Chinese food, traditional American food), and/or searching the mall for particular restaurant meals (e.g., Shepherds' pie and/or Peking duck). It is noted that, in various embodiments, one or more search plugins might correspond to a particular store and/or restaurant within the mall, to multiple stores and/or restaurants, and/or to one or more sections of the mall.

As another example, in the case where the node and/or other computer was at a transport hub, one or more plugins providing for searching regarding arrivals and/or departures, and/or services available at the hub (e.g., check-in, baggage services, customs service, medical services, food services, and/or shops) might be employed and/or received. As a further example, in the case where the node and/or other computer was at a housing location, office building, or professional building, one or more plugins providing for searching of tenants and/or services might be employed and/or received.

It is noted that, in various embodiments, in the case where one or more plugins are available for receipt (e.g., with the user entering a building and/or area with her node and/or other computer), the user might be queried (e.g., via a GUI and/or other interface provided by the node and/or other computer) as to whether or not she wished to receive one or more of the available plugins. To illustrate by way of example, the user might be provided with the indication “There are new plugins available. Do you want to download them now?”. The user might, in various embodiments, be given the option to provide an affirmative or non-affirmative answer with respect to receipt of all available plugins, and/or might be able to individually provide an affirmative or non-affirmative answer with respect to receipt of each available plugin. In view of the user's response to the query, for example, one or more of the available plugins might or might not come to be possessed by the node and/or other computer.

In various embodiments, the node and/or other computer might receive one or more plugins for an area with entry into to that area, and/or might employ one or more already-possessed plugins. Accordingly, for example, in the case where the user of the node and/or other computer walks into a shopping mall, the node and/or other computer might receive one or more appropriate plugins (e.g., of the sort discussed above), and/or might employ one or more already-possessed appropriate plugins (e.g., of the sort discussed above).

It is noted that, in various embodiments, as an alterative to and/or in addition to consideration of location, other factors might be taken into account in determination of one or more search plugins to be employed. Such factors other than location might, for instance, be via other contextual information (e.g., retrieved from maintained and/or received node information arrays) and/or preferences. Accordingly, for example, in the case where the node and/or other computer was at a building and/or area, only plugins, corresponding to that building and/or area and consistent with such contextual information and/or preferences (e.g., plugins believed to be of interest in light of such preferences and/or context) might be employed and/or received.

To illustrate by way of example, in the case where the node and/or other computer is at a shopping mall, only plugins corresponding to stores and/or restaurants consistent with such contextual information and/or preferences (e.g., stores and/or restaurants believed to be of interest in light of preferences and/or context) might be employed and/or received. Such determination of interest might, for example, take into account preferences (e.g., preferences set by the user indicating, for instance, her hobbies, preferred foods, and/or preferred types of clothing). As another example, such determination of interest might take into account contextual information (e.g., retrieved from maintained and/or received node information arrays). Accordingly, for instance, time and/or date might be taken into account in such determination of interest (e.g., plugins corresponding to lunch-type restaurants might be employed in the case where it is lunchtime, and/or plugins corresponding to camping supply stores might be employed in the case where it is summer time and/or summertime is near).

To further illustrate by way of example, in the case where the node and/or other computer was at an airport, only plugins corresponding to arrivals and/or departures, and/or services consistent with such contextual information and/or preferences might be employed and/or received. Accordingly for instance, one or more plugins corresponding to customs services might only be employed and/or received in the case where information and/or preferences indicated arrival at the airport from a foreign country (e.g., via logged location information indicating such arrival).

It is noted that, in various embodiments, branding might be employed. For example, branding might be employed for search plugins. Branding might, for instance, provide association with trademark names, brand names, and/or names of buildings and/or areas (e.g., names of buildings and/or areas of the sorts discussed above). A user might be made aware of branding (e.g., branding associated with a plugin that is being employed, a possessed plugin, and/or a plugin that is being received and/or has been received) in a number of ways.

For instance, branding information might be conveyed to the user via GUI and/or other interface provided by the node and/or other computer. For example, text and/or graphics conveying a brand might be displayed. Such text and/or graphics might, for example, convey a brand logo. It is noted that, in various embodiments, the user might be made aware of branding associated with a search plugin such that the user learns of the source of search hits and/or learns the nature of a search plugin. To illustrate by way of example, the user might be made aware (e.g., in a manner analogous to that discussed above) that search results came from a search plugin sponsored by the main department store in the mall in which the user was using her phone, and/or that the search plugin was intended to help shoppers find products and services in the mall. Branding might, in various embodiments, be implemented such that some or all of one or more interfaces (e.g., GUI search interfaces) provided to the user convey branding (e.g., in a manner analogous to that discussed above), and/or such that one or more specific interface elements provided to the user convey branding (e.g., in a manner analogous to that discussed above). In various embodiments, in the case where search is performed, the node and/or other computer, and/or the network to which the node and/or other computer is connected, might provide to an entity (e.g., a search engine and/or service provider) information regarding one or more plugins employed in the search. Such information might, for example, be employed by the entity in charging, based on number of hits, companies having their information searchable (e.g., stored on one or more indexes).

As noted above, in various embodiments a search may make use of multiple search plugins. For example, search requested by the user (e.g., via text entry via a GUI and/or other interface, and/or via dragging of the sort discussed above) might be carried out in a manner employing multiple search plugins (e.g., simultaneously). As also noted above, in various embodiments contextual information (e.g., retrieved from maintained and/or received node information arrays) and/or preferences might be taken into account in choosing search plugins to be employed. It is noted that, in various embodiments, contextual information (e.g., retrieved from maintained and/or received node information arrays) and/or preferences might be employed in search plugin prioritization (e.g., in search plugin use and/or in search plugin choice). Such prioritization might, for example, indicate that results from certain search plugins should receive greater weighting than results from certain other search plugins. Such application of weighting might, for instance, affect what search results are displayed to the user, and/or the order in which search results are displayed to the user. It is noted that, in various embodiments, various such functionality might be employed at the same time. To illustrate by way of example, such employment of multiple search plugins (e.g., simultaneously), such consideration of contextual information and/or preferences in plugin choice, and/or such consideration of contextual information and/or preferences in search plugin prioritization might be employed at the same time.

It is noted that, in various embodiments, considered contextual information (e.g., from maintained and/or received node information arrays) might, for instance, include information answering questions such as “what?”, “where?”, “when?”, “who?”, “why?”, and “how?”. In various embodiments, map plugins may be employed and/or downloaded. Such map plugins might, for instance, be employed by the above-described map viewer software module. Such map plugins might, for example, provide different sizes of maps, different zoom levels of maps, maps of different locations, and/or maps received from different locations. It is noted that, in various embodiments, coordinates may indicate the outlines of the maps (e.g., with respect to different map zoom levels and/or map sizes).

Such information, and/or search results tagged with location information, might, in various embodiments, be employed in search result display (e.g., via map view). It is noted that, in various embodiments, search results may, in addition to or as an alternative to being tagged with location information, be tagged with other information. Such other information might, for example, include images and/or logos.

As noted above, in various embodiments, one or more maintained and/or received node information arrays may be taken into account in search operation and/or selection of search plugins. It is further noted that, in various embodiments, user preferences might be taken into account in search operation and/or selection of search plugins.

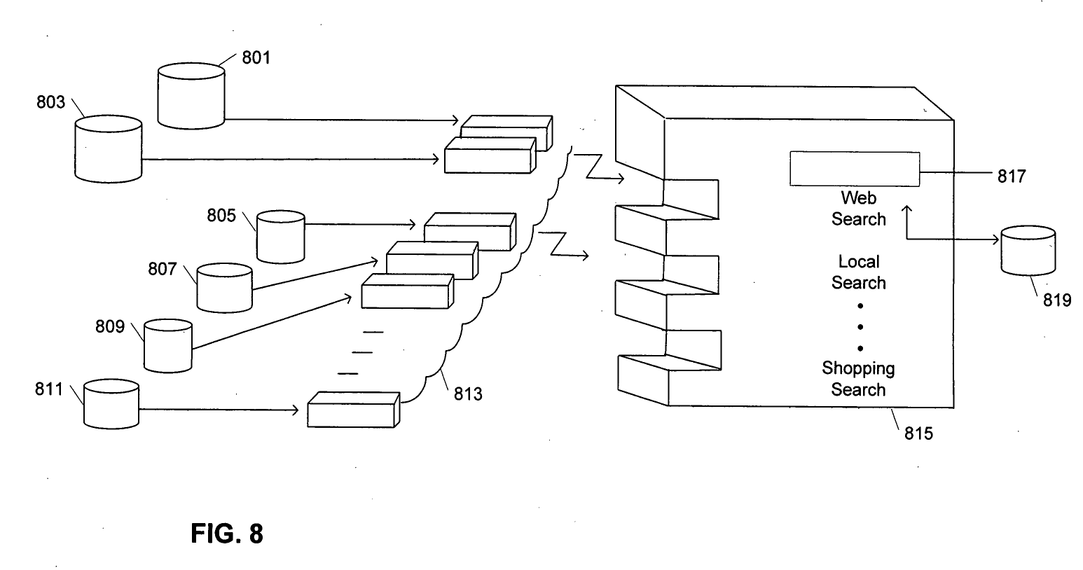

Shown in FIG. 8 is an exemplary descriptive figure depicting various aspects of various embodiments of the present invention. Shown in FIG. 8 are Google web index 801, Yahoo web index 803, yellow pages sources 805-811, search plugins 813, search software 815, search query box 817, and contextual engine 819. Google web index 801, Yahoo web index 803, yellow pages sources 805-811, and plugins 813 might, for example, be as discussed above. Search software 815 might, for example, include search software module 701. Search query box 817 might, for instance, be implemented as discussed above with respect to GUIs and/or other interfaces employable by users in requesting search. Contextual engine 819 might, for example, act as described herein to provide contextual information (e.g., to be taken into consideration for searching operations).

Branding might, in various embodiments, be employed for plugins 813 (e.g., as discussed above). Accordingly, for instance, one or more interfaces provided to the user and/or one or more interface elements may (e.g., as discussed above) convey branding. Moreover, in various embodiments, based on country and/or location context, plugins 813 may change dynamically. Such functionality might, for example, be implemented as discussed above. It is additionally noted that, in various embodiments, the user may be able to dynamically select by tabs at the same time one or more of plugins 813. Such functionality might, for example, be implemented as discussed above. It is additionally noted that although only “web search”, “local search”, and “shopping search” are stated by FIG. 8, an unlimited number of categories are possible.

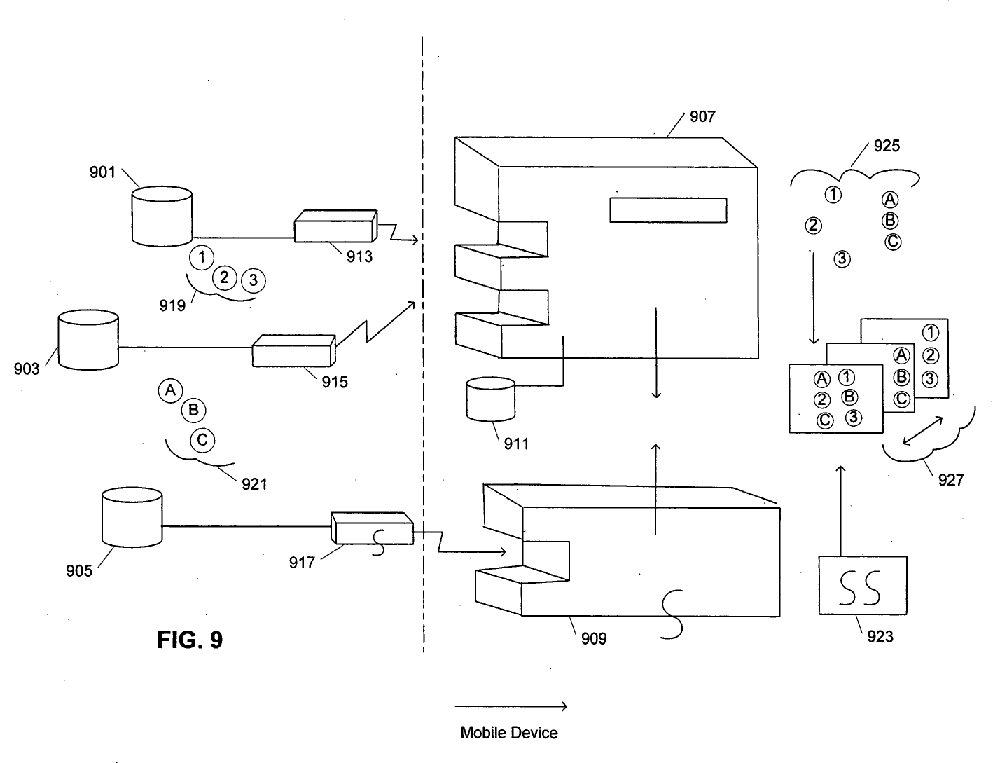

Shown in FIG. 9 is a further exemplary descriptive figure depicting various aspects of various embodiments of the present invention. Shown in FIG. 9 are yellow pages sources 901 and 903, map source 905, search software 907, map software 909, contextual engine 911, search plugins 913 and 915, map plugin 917, data 919, data 921, map 923, data 925, and tabbed display 927. Yellow pages sources 901 and 903, and map source 905 might, for instance, be as discussed above. Search software 907 might, for example, include search software module 701. Map software 909 might, for example, perform various map rendering operations (e.g., as discussed herein), and might, for example, include map viewer software module 703. Contextual engine 911 might, for instance, act as described herein to provide contextual information. Search plugins 913 and 915, and map plugin 917 might, for instance, be as discussed above.

Data 919 might, for instance, be received by plugin 913 from yellow pages source 901 as search employing that plugin is performed. Likewise, data 921 might, for instance, be received by plugin 915 from yellow pages source 903 as search employing that plugin is performed.

Map 923 might, for instance, include map data of the sort discussed herein. Data 925 might, for example, include an aggregate of data yielded by searching operations. Accordingly, for instance, data 925 might be a data aggregate including data 919 and data 921. Tabbed display 927 might, for example, be of the sort discussed herein. As depicted in the example of FIG. 9, made available to the user via tabbed display 927 are map 923 and data 925.

It is noted that, in various embodiments, search results may be tagged. For instance, search results might be tagged with geographical information such as, for instance, Global Positioning System (GPS) latitude and longitude information. Search results may, in various embodiments, be so tagged as produced by yellow pages sources 901 and 903. Alternately or additionally, in various embodiments such tagging might occur by action of the node and/or other computer. Search plugin modules, various software running at the node and/or other computer, and/or GPS circuitry of the node and/or other computer might, for example, be employed. It is further noted that, in various embodiments, plugins (e.g., plugins 913 and 915) may be dynamically loaded. Such functionality might, for instance, be implemented as discussed above.

Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal sever, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

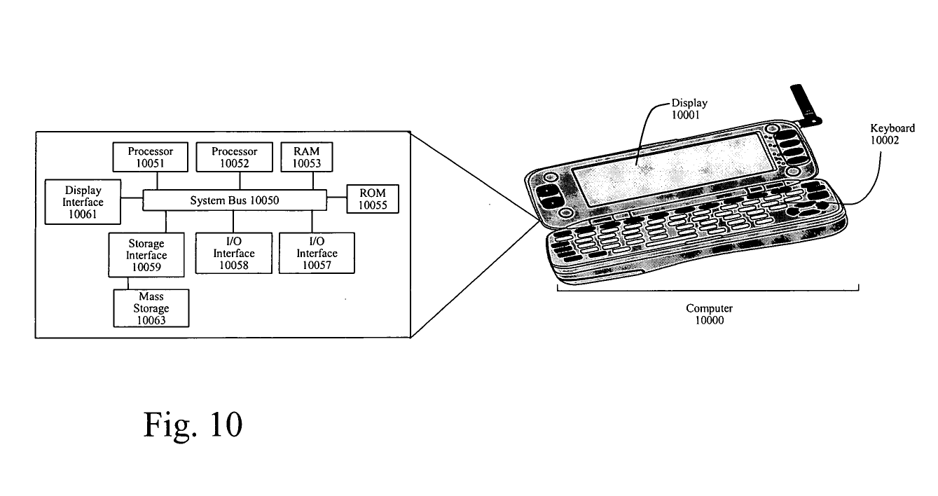

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 10 is an exemplary computer employable in various embodiments of the present invention. Exemplary computer 10000 includes system bus 10050 which operatively connects two processors 10051 and 10052, random access memory 10053, read-only memory 10055, input output (I/O) interfaces 10057 and 10058, storage interface 10059, and display interface 10061. Storage interface 10059 in turn connects to mass storage 10063. Each of I/O interfaces 10057 and 10058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 10063 may be a hard drive, optical drive, a memory chip, or the like. Processors 10051 and 10052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, or an IBM, Toshiba, or Sony Cell processor. Computer 10000 as shown in this example also includes a touch screen 10001 and a keyboard 10002. In various embodiments, a mouse, keypad, and/or interface might alternately or additionally be employed. Computer 10000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

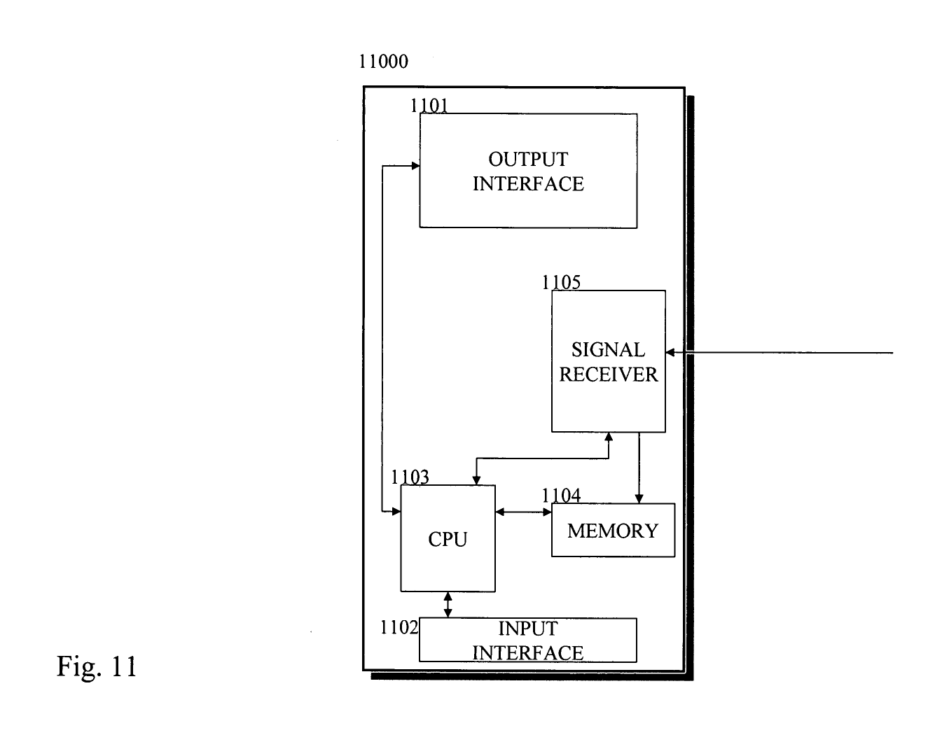

Shown in FIG. 11 is a block diagram of a terminal, an exemplary computer employable in various embodiments of the present invention. In the following, corresponding reference signs are applied to corresponding parts. Exemplary terminal 11000 of FIG. 11 comprises a processing unit CPU 1103, a signal receiver 1105, and a user interface (1101, 1102). Signal receiver 1105 may, for example, be a single-carrier or multi-carrier receiver. Signal receiver 1105 and the user interface (1101, 1102) are coupled with the processing unit CPU 1103. One or more direct memory access (DMA) channels may exist between multi-carrier signal terminal part 1105 and memory 1104. The user interface (1101, 1102) comprises a display and a keyboard to enable a user to use the terminal 11000. In addition, the user interface (1101, 1102) comprises a microphone and a speaker for receiving and producing audio signals. The user interface (1101, 1102) may also comprise voice recognition (not shown).

The processing unit CPU 1103 comprises a microprocessor (not shown), memory 1104 and possibly software. The software can be stored in the memory 1104. The microprocessor controls, on the basis of the software, the operation of the terminal 11000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 11, alternatively, middleware or software implementation can be applied. The terminal 11000 can, for instance, be a hand-held device which a user can comfortably carry. The terminal 11000 can, for example, be a cellular mobile phone which comprises the multi-carrier signal terminal part 1105 for receiving multicast transmission streams. Therefore, the terminal 11000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
consulting location information corresponding to a node;
receiving, in accordance with the location information, one or more search plugins; and
employing one or more of the search plugins in performing one or more searches regarding a location corresponding to the location information.

2. The method of claim 1, further comprising consulting non-location contextual information.

3. The method of claim 2, wherein some or all of the received search plugins are received in accordance with some or all of the non-location contextual information.

4. The method of claim 1, wherein the location corresponding to the location information is a shopping mall.

5. The method of claim 1, wherein the location corresponding to the location information is a transport hub.

6. The method of claim 1, wherein the location corresponding to the location information is one or more of a housing location, an office building, and a professional building.

7. The method of claim 6, further comprising consulting one or more node information arrays.

8. The method of claim 6, further comprising receiving from one or more remote nodes some or all of one or more node information arrays corresponding to the remote nodes.

9. A method, comprising:
providing to a user, via a map display, search hit indicators, wherein the search hit indicators are placed on the map display in accordance with geographical information; and
receiving, from the user, one or more requests for further information regarding one or more search hits,
wherein a first set of the search hit indicators corresponds to search hit results yielded by a first search plugin, and
wherein a second set of the search hit indicators corresponds to search hit results yielded by a second search plugin.

10. The method of claim 9, wherein some or all of the search hit plugins are selected for employment in view of contextual information.

11. The method of claim 9, wherein one or more of the search hit indicators have corresponding keypad buttons.

12. The method of claim 11, wherein one or more of the keypad buttons may be pressed by the user to request further information regarding one or more search hits.

13. The method of claim 9, further comprising receiving the geographical information.

14. The method of claim 9, wherein the first search plugin and the second search plugin perform different searches.

15. The method of claim 9, wherein the first search plugin and the second search plugin access different search engines.

16. A system, comprising:
a memory having program code stored therein; and
a processor disposed in communication with the memory for carrying out instructions in accordance with the stored program code;
wherein the program code, when executed by the processor, causes the processor to perform:
consulting location information corresponding to a node;
receiving, in accordance with the location information, one or more search plugins; and
employing one or more of the search plugins in performing one or more searches regarding a location corresponding to the location information.

17. The system of claim 16, wherein the processor further performs consulting non-location contextual information.

18. The system of claim 17, wherein some or all of the received search plugins are received in accordance with some or all of the non-location contextual information.

19. The system of claim 16, wherein the location corresponding to the location information is a shopping mall.

20. The system of claim 16, wherein the location corresponding to the location information is a transport hub.

21. The system of claim 16, wherein the location corresponding to the location information is one or more of a housing location, an office building, and a professional building.

22. The system of claim 21, wherein the processor further performs consulting one or more node information arrays.

23. The system of claim 21, wherein the processor further performs receiving from one or more remote nodes some or all of one or more node information arrays corresponding to the remote nodes.

24. A system, comprising:
a memory having program code stored therein; and
a processor disposed in communication with the memory for carrying out instructions in accordance with the stored program code;
wherein the program code, when executed by the processor, causes the processor to perform:
providing to a user, via a map display, search hit indicators, wherein the search hit indicators are placed on the map display in accordance with geographical information; and
receiving, from the user, one or more requests for further information regarding one or more search hits,
wherein a first set of the search hit indicators corresponds to search hit results yielded by a first search plugin, and
wherein a second set of the search hit indicators corresponds to search hit results yielded by a second search plugin.

25. The system of claim 24, wherein some or all of the search hit plugins are selected for employment in view of contextual information.

26. The system of claim 24, wherein one or more of the search hit indicators have corresponding keypad buttons.

27. The system of claim 26, wherein one or more of the keypad buttons may be pressed by the user to request further information regarding one or more search hits.

28. The system of claim 24, wherein the processor further performs receiving the geographical information.

29. The system of claim 24, wherein the first search plugin and the second search plugin perform different searches.

30. The system of claim 24, wherein the first search plugin and the second search plugin access different search engines.
